(19) United States
(12) Patent Application Publication
(10) Pub. No.: US 2004/0145603 A1
(43) Pub. Date: Jul. 29, 2004

(54) Online multimedia presentation builder and presentation player

(76) Inventor: Stephen Michael Soares, Hoschton, GA (US)

Correspondence Address: Stephen Soares, 1748 Mineral Springs Rd, Hoschton, GA, 30548, US

(21) Appl. No.: 10/672,682

(22) Filed: Sep. 26, 2003

Related U.S. Application Data
(60) Provisional application No. 60/414,494, filed on Sep. 27, 2002.

(51) Int. Cl. G09G 5/00

(52) U.S. Cl. 345/730

(57) ABSTRACT

This invention is an online multimedia electronic solution for both building and playing of online presentations. The Presentation Builder is an What You See Is What You Get (WYSIWYG) interface that enables Internet users to upload, design, rotate, resize, create a layout, change fonts, change colors, hyper link, and drag and drop digital assets they supply or that are offered by the server into an online editor environment; captions, known as text and also streaming audio may be added. The Presentation Builder allows users to log out and later return to update changes to their existing presentations and republish the results; the Builder may be accessed from any computer on the Internet. The presentation is then viewed in the Presentation Player (a play-only-mode) without editing capabilities; it can be viewed via a link in email as a realistic looking book (three-dimensional) with the transitional effect of page turning.

### CROSS-REFERENCE TO RELATED APPLICATIONS:

This application claims the benefit of U.S. Provisional Application No. 60/414494 filed Sep. 27, 2002.

### FEDERALLY SPONSORED RESEARCH

NOT APPLICABLE

### SEQUENCE LISITNG OF PROGRAM

NOT APPLICABLE

### BACKGROUND OF THE INVENTION—FIELD OF INVENTION

This present invention relates to a an online multimedia system for the building and playing of online presentations that have capabilities enabling an internet user to create, view and easily distribute presentations in a web browser more particularly to methods and systems for creating and presenting digital assets over the Internet for a person using a personal computer; it subsequently renders data in a real time playback environment, which has a realistic method of viewing pages in a familiar environment, similar to the conventional printed version of turning pages in a real book.

### BACKGROUND OF THE INVENTION

The advent of personal computers and access to the Internet has resulted in individual users having access to a wide variety of digital media. Currently, available programs rely on users being fairly sophisticated with computers, computer technology, and computer operations. Novice computer users can have difficulty using interfaces requiring a high degree of computer familiarity.

A need exists for improved techniques for creating multimedia titles that simplify the development process and provide greater flexibility, functions, and forms for individual users. Currently, the online photo albums (more similar to slide shows) that consumers are accustomed to using, such as, www.dotphoto.com, www.ofoto.com, and www.shutterfly.com allow the consumer to upload their personal digital assets; yet, the user is only shown a thumbnail page which has the uploaded digital assets. In order to view the photos, a user must then click on one of the thumbnails to enlarge the photo thus increasing the workload of viewing photos. In order to share the photos with others, the user must send out e-mails, which contain passwords that the recipients must use in order to be able to view the secure online photo albums and such. Current methods can be very time consuming for individuals.

Several prior art methods can be characterized in several groups. One group has a page turning ability as per the following U.S. Pat No. 6,407,757 to Ho (Jun. 18,2002), U.S. Pat. No 20,020,054,121A1 to Ho (May9,2002 ), U.S. Pat. No 6,340,980 to Ho (Jan. 22,2000), and U.S. Pat. No. 6,064,384 to Ho (May16,2000) all assigned to E-Book Systems PTE Ltd; yet this program must be installed on a personal computer to run, it is not a web based application. Also, U.S. Pat. No. 5,586,245 to Fujitsu (Dec. 17,1996) is a data process having page turning function for managing plurality of data sets each containing plurality of data units of different kinds and or the same kind. U.S. Pat. No. 5,053,762 to Sarra (Oct. 1,1991) is an apparatus for simulating a partially turned page on a video screen. U.S. Pat. No. 5801713 to Endo (Sep. 1,1998) is a data browsing apparatus that displays data automatically in an automatic page-turning mode.

Another group allows the user to browse information stored electronically. The following U.S. Pat. No. 5,463,725 to Henckel (Oct. 31,1995) and U.S. Pat. No. 5,870,092 to Bedford-Roberts (Feb. 2,1999) and U.S. Pat. No. 20,010,050,658 to Adams (Dec. 12,2001) displays pages and enables the user to browse in a “page turning mode”; however, these methods only allow the user to recreate this motion by either touching the screen with a hand or a pointing devise on a pen sensitive screen.

Still another group has created U.S. Pat. No. 6,289,363 to Consolatti ((Sep. 11,20001) that creates multimedia titles with rapid construction, number of scenes, which are analogous to pages in a book, each scene may include content such as text, graphics animation, video clips, music, etc., and or more “hot spots” through which end user may interact with the scene. The difference is that the user may jump scenes and the pages do not flip the same. U.S. Pat. No. 20,020,070,982 to Hill (Jun. 13,2002) is a user interface method and system for presenting digital media to user in familiar environment presented to user as photo albums, but it has no page turning ability.

Still another group, U.S. Pat. No.

20,020,035,697 to McCurdy (Mar. 21,2002) is for distributing and viewing electronic documents that are similar to actual magazines; unfortunately the user is not able to use his content. Also, U.S. Pat. No. 6,496,803 to Seet, (Dec. 31,2002) is for a magazine type advertisement in a book-like interface. U.S. Pat. No. 6,199,082 to Ferrel (Mar. 6,2001) allows the publisher to change the format, not the end user.

Another group, U.S. Pat. No. 6,324,545 to Morag (Nov. 27,2001) automatically arranges some of the images to fit a format of an album. The individual isn't given the freedom to create, but must adhere to the formatted album. U.S. Pat. No. 20,020,101,539 to Yokota, (Aug. 1,2002) remotely creates electronic albums by using pictures taken at mobile terminals and places a time reference on the photo; the end user doesn't create the album himself.

Still another group, U.S. Pat. No. 20,020,083,101 to Stuart (Jul. 27,2002) is a system for displaying images in a 3D virtual book; it also has an indexing function and bookmark. It customizes indexes and or table of contents. U.S. Pat. No. 5,696,982 to Tanigawa (Dec. 9,1997) is an electronic display apparatus for page retrieval, the number of times pages have been viewed is displayed.

U.S. Pat. No. 5,937,419 to Oshiro (Aug. 14,1999) is a screen data table that stores information of page turning buttons for individual pages to be turned and information of pages displayed by the page turning buttons. The page turning apparatus has a screen page hierarchical data table corresponding to functions of pages that can be displayed. U.S. Pat. No. 5,764,227 to Ishimine (Jun. 9,1998) is where one page lies on top of another; the page-turning command is entered through an input devise, a designator specifies a page which should become the first page of the document. U.S. Pat. No. 5,146,555 to Kiyohara (Sep. 8,1992) is for a high-speed page turning control system and method, which is capable of representing the page turning process by actively displaying the image if a compressed window on a display. U.S. Pat. No. 1,026,221 to Kiyohara (Jan. 27,1989) actively represents a page-turning process by reading out and displaying read positions of pieces of image information of a turned page and a stationary page according to display priority, the size of the rectangular area of the turned page, and the thinning-out quantity.

Still another group U.S. Pat. No. 5,900,876 to Yagita (May 4,1999) is for an icon displayed in the form of an open book that is designated with a mouse.

This present invention has two parts: a Presentation Builder is a server based application available to users through a standard web browser. The second part is the presentation player which is available to users in both the web browser or as a standalone application. This present invention has been developed so that little expertise is required of the end user, yet the consumer is able to arrange their personal digital assets in an online Presentation Builder (Server Application) according to their own personal preferences. This invention allows users an online solution for editing the layout of a series of digital assets and adding their own text and also streaming audio. This invention displays digital assets in the Presentation Player on page spreads having an appearance, layout and quality similar to that of a printed publication. This current invention allows the end user to email a simple link to thier presentation directly to recipients who are able to instantly view the photos in the Presentation Player without having to go to a special web site and remember a password.

An online Presentation Builder and Presentation Player that works in the web browser, has not been developed that provides the user with a simplified interface method that creates an electronic document to display their digital assets that include both text and streaming audio in a virtual graphical representation of a realistic book with turning pages.

### BACKGROUND OF INVENTION—OBJECTS AND ADVANTAGES

Accordingly, several objects and advantages of my invention are:

(a) The Presentation Builder allows a consumer with digital assets to upload, design, rotate, create a layout, add captions, fonts, colors, hyper linking and drag and drop their personal digital assets in an online editor environment;

(b) This environment supports real time professional effects, which include shadowing, anti aliasing and translucent effects;

(c) The Presentation Builder also includes a mechanism for resizing and orienting user assets based on the style of the presentation;

(d) The Presentation Builder allows users to log out and later return to update changes to their existing presentations, and republish their results;

(e) The Presentation Player is a play-only-mode without editing capabilities;

(f) The Presentation Player, the recreated presentation (originally authored in the Presentation Builder) are now played back in a three-dimensional, shadow-casting interface, resembling a book that has a realistic page turning representation;

(g) The Presentation Player can be viewed by recipients upon receiving the email, thus there is no need for special passwords or logins;

(h) The Presentation Builder may also be accessed from any computer on the Internet, not just an individuals own personal computer, thus increasing the users ability to use the program, making the program more prone to adhoc user updates while at a remote or on-site location. The ability to update the presentations from any location can greatly enhance collaborative efforts between multiple users working on a single presentation.

While certain embodiments of the present invention have been illustrated and described, it will be appreciated that various changes can be made without departing from the spirit and scope of the invention. Other familiar ramifications for this invention could include, but are not limited to the following possibilities: presentation generator, catalog maker, promotionals, leaflets, brochures, slide-shows, magazines, and financial data analysis reports, scrapbooks, albums, photo albums, voice over narration, text, graphics, user defined hot links, animation, audio, video, end user interaction with each page, user defined streaming audio, etc. Still further objects and advantages of my invention will become apparent from a consideration of the drawings and ensuring description.

### SUMMARY

This invention is an online electronic solution for users to upload, edit and layout digital assets they supply or offered by the server, add captions known as text and also streaming audio and then have the same assets viewed in a realistic looking book with the transitional effect of page turning. This invention is an online What You See Is What You Get (WYSIWYG) interface for building presentations online. Once the content is organized, arranged and published (i.e. stored) in the Presentation Builder, the presentation can then be viewed in the Presentation Player from anywhere on the Internet.

### BRIEF DESCRIPTION OF THE DRAWINGS

FIG. 0 is a flow diagram depicting the Presentation Building process.

FIG. 1 depicts an interface screen presented to user in accordance with an embodiment of the present invention, and depicts what is known as The Editor in the Presentation Builder. A set of menu operations is made available to the user in the interface. This interface is similar to an open book where user supplied digital assets can be positioned using the mouse and menu options to change particular attributes for each element.

FIG. 2 depicts an interface screen presented to user in accordance with an embodiment of the present invention, and depicts what is known as the Add Panel in the Presentation Builder. A different set of menu operations is made available to the user in this interface allowing the user to add both captions and other digital assets into The Editor.

FIG. 3 depicts an interface screen presented to user in accordance with an embodiment of the present invention, and depicts what is known as the Options Panel. This controls a set of global attributes for all elements within the Presentation Builder for a particular building session.

FIG. 4 depicts an interface screen presented to user in accordance with an embodiment of the present invention, and depicts what is known as the Photo Review and Photo Orientation Editor Panel in the Presentation Builder. A set of menu options is made available to the user in this interface allowing the user to review, orient, accept or decline the user's uploaded digital assets.

FIG. 5 is a flow diagram depicting the Presentation Player process.

FIG. 6 is a series of images depicting the Spread Animation Definition.

### DETAILED DESCPTION OF THE ILLUSTRATIVE EMBODIMENTS

In accordance with embodiments of the present invention, a user interface is provided for the editing and presentation of user-supplied digital assets facilitated in client/server architecture.

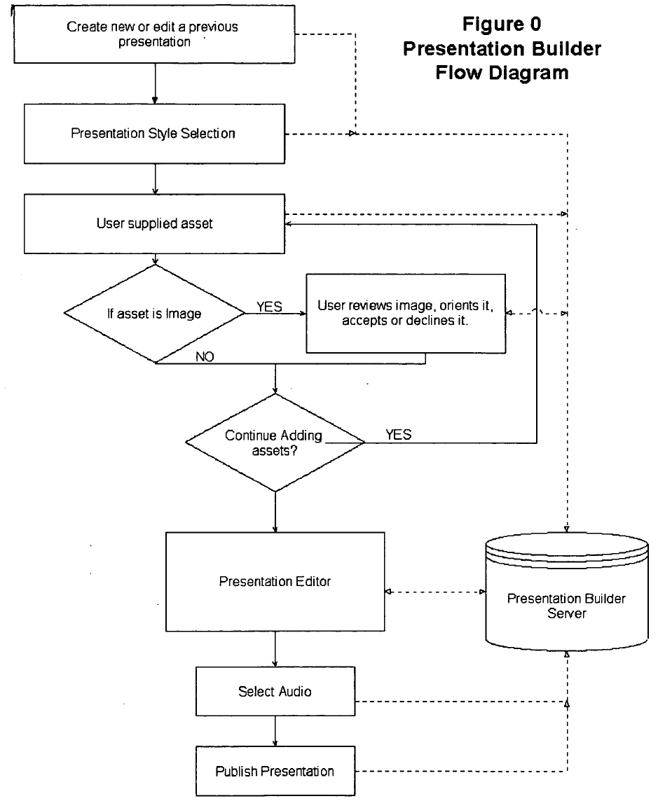

### FIG. 0—Flow Diagram in Detail of Presentation Builder

Create New or Edit A Previous Presentation:

A presentation is a collection of digital assets applied to a particular style, defined and arranged by a presentation script. This allows the user to create, name, and open a particular presentation for editing.

Presentation Style Selection:

User selects the look of the Presentation to be edited. This look can vary in size, color, and cover design and aspects of the functionality of the presentation. The style selected also controls certain aspects of how the user's digital assets will be treated when it is added to the presentation; these are called style rules. At any time, during the build process, the user may revisit the presentation style and may change the selected style.

User Supplied Assets:

This sequence allows the user to send digital assets from their client device to the server for being added to the presentation. This facility also allows the user to remove assets that have not been used in the presentation. This produces a collection of assets to be used in the presentation that are specific to the style chosen by the user. For example, the user selects style #A—the uploaded image data then is resized to the particular dimensions of style #A due to style rules.

User Orients Image:

When the user uploads an image, the user is presented with a small version of the image, allowing them to perform particular operations on the image such as rotating, cropping, etc. The server performs all the user's edits on the originally uploaded assets and any particular rules for the given selected style. Numerous times through this sequence produces the set of assets to be used in the presentation.

Presentation Editor:

The user determines how to arrange their digital assets in the Presentation Editor. The Presentation Editor creates a series of spreads. A spread is a representation of the user chosen selected style where they may place and position their digital assets. Within the Presentation Editor, across a number of spreads, the user is allowed to add, edit, remove, position, and set attributes for their own digital assets, which may include link scripts that give the asset some sort of functionality. Upon exit of the Presentation Editor, the updated presentation script is sent back to the server to store every aspect of the presentation. Users have the ability to choose any font available on their computer, and have it used during the presentation building process. This rendered font data is encoded and compressed as a 256 color saturation image raster and is compressed through a series of compression schemes and embedded within the presentation script. The script may also include placement, sizes, attributes, text strings and rasterized image & font data.

Select Audio:

The user may select the audio to be played/streamed during the Presentation playback. Also supported is the mixing of different audio streams depending on the current spread of the presentation in the playback module.

Publish:

When the user selects publish—the server processes the user's presentation script and begins to build a bundle. The style, audio, and only the user-selected digital assets included in the Presentation Editor script are included in the bundle. The bundle is a compressed data collection that contains the necessary assets to completely recreate the user's presentation. All the spreads in the user's presentation are then viewable in the Presentation Player module.

All of the above steps are considered to part of the Presentation Builder.

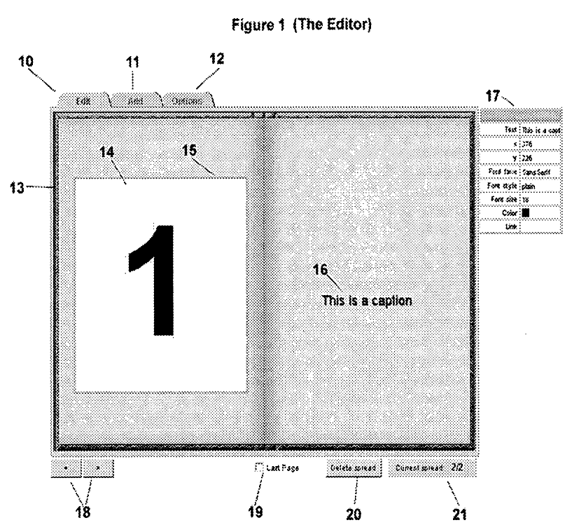

FIG. 1 is The Editor Panel where users layout, organize and arrange their digital assets in a drag and drop style interface. The editing area is 13 the display area representing a book and defines the entire region where users may place their content. The tab area 10, 11, and 12, allow the user to navigate between different modes of the Presentation Builder. Add tab 11 takes the user to the Add Panel. Options tab 12 takes the user to the Options Panel. Edit tab 10 returns the user to the Editor Panel. Sample image 14 is an uploaded user asset surrounded by a soft anti-aliased shadow 15 as if cast by the users image data. A sample caption 16 can also contain anti-aliased elements and drop shadows. These elements of shadows and anti-aliasing occur in real time as the user drags and positions their digital assets. The property window 17 shows related attributes for a currently selected item the user has selected. These attributes include, but are not limited to positioning data, text, font face, font style, font size, color, and a link to an Internet address or a predetermined presentation function. Page forward and page backward buttons 18 allow user to navigate to different page spreads. In order to determine the last page of the Presentation, the user should check the last page 19. It is possible for a user to delete a page spread; they should click on the delete-spread button 20 in order to eliminate a page spread previously added. The current spread 21 acknowledges what page the user is on and how many pages are currently in the Presentation Builder module that the user is editing.

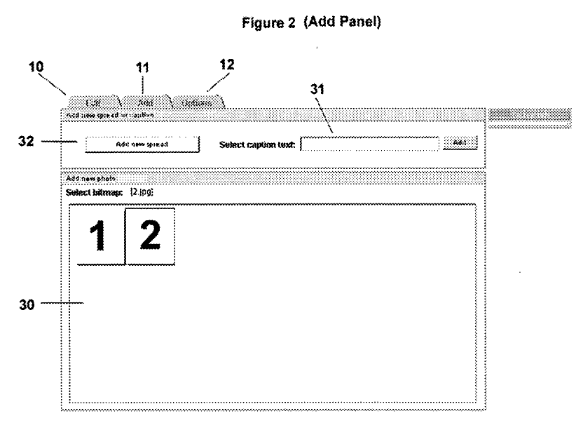

FIG. 2 is the Add Panel where users can both select and create assets to be placed in The Editor. The thumbnail selector 30 allows users to visually select one of their uploaded digital assets via a thumbnail representation as well as a highlighted file name. Once a thumbnail is selected, the user is returned to The Editor and the asset they choose is loaded into The Editor and is ready for positioning and to have its particular attributes changed. The user is allowed to create captions (text string) via an input control 31. The user then will press enter or the add button and have that text string appear in The Editor for positioning. The Add new spread 32 is the area where a user will click to add a new spread or set of pages to The Editor in order to add more of their digital assets to the Presentation Builder.

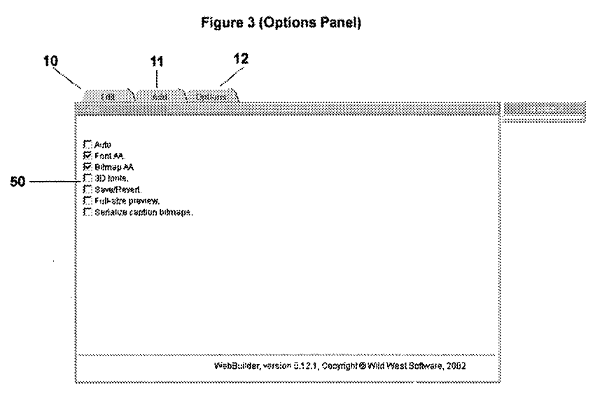

FIG. 3 is the Options Panel, an area where global properties for the entire presentation can be edited and configured. The control area 50 can show different ways in which the data can be encoded as well as global visual attributes for all digital assets in the presentation. Certain user interface elements, such as allowing the user to undo operations in The Editor can be activated or turned on or removed via options within this panel.

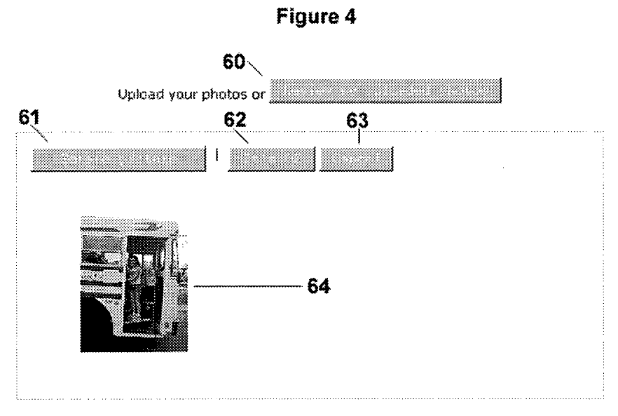

FIG. 4 is the Photo Review and Photo Orientation Editor Panel in the Presentation Builder. The user is able to select the Review my Uploaded Photos 60 button in order to view all of the digital assets that the user has uploaded for use in the present Presentation Builder that the user is currently working within. The user is able to orient their uploaded digital assets by selecting the Rotate picture 61 button. If the user wants to accept an uploaded digital asset into the Presentation Builder, they should select the It's OK 62 button. If the user does not want to accept an uploaded digital asset into the Presentation Builder, they should select the Cancel 63 button. The digital asset that has been uploaded for the user to view is seen on screen in area 64. Once the user has uploaded, oriented, accepted and selected the digital assets that they choose to use to build their presentation, the user will go to The Editor. Cropping ability will also be included on this panel.

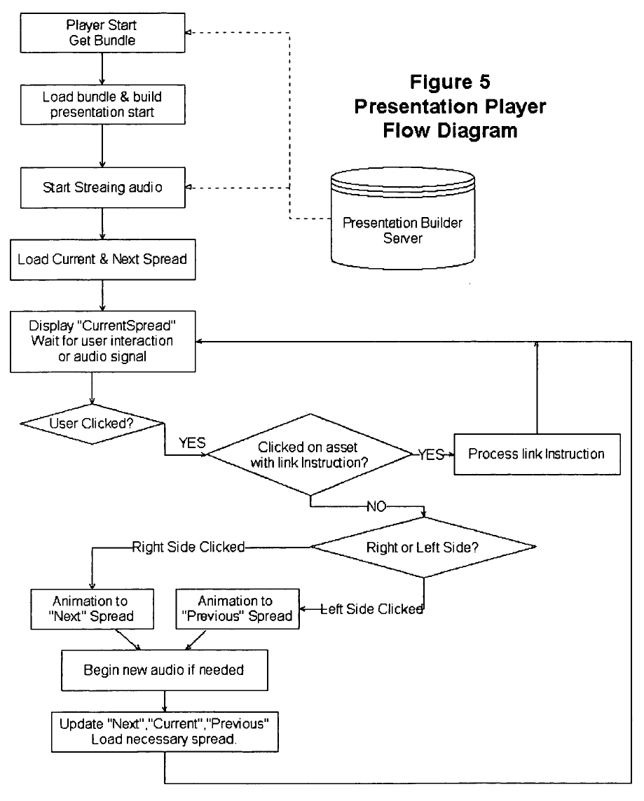

### FIG. 5—Flow Diagram in Detail of Presentation Player

Player Start/Get Bundle:

When the Presentation Player module starts, the bundle gets loaded from a local or remote location. This may include asynchronously transferring the bundle from a remote Internet location.

Load Bundle & Build Presentation Start:

From within the bundle, the presentation script is loaded and decoded into a set of queriable functions. All the assets related to the presentation style are loaded & decompressed from the presentation script. The start of the presentation is now viewable on screen. The presentation player keeps a working list of rendered spreads named “previous”, “current”, and “next.” The current spread index is set to zero. The current spread index is used to track and maintain what spread is currently being viewed.

Start Streaming Audio:

If streaming audio had been selected (during the Presentation Builder stage) to be played, the audio that was selected would now begin playing in the Presentation playback module.

Load Next Spread:

The module starts by loading “current” and “next” spread. The player does not load “previous” spread because a “previous” spread does not exist at the beginning of the Presentation Player module. Internally the player updates the working list “next” spread, decodes, and renders the “next” spread in the sequence in an off-screen buffer.

User Clicks on Presentation:

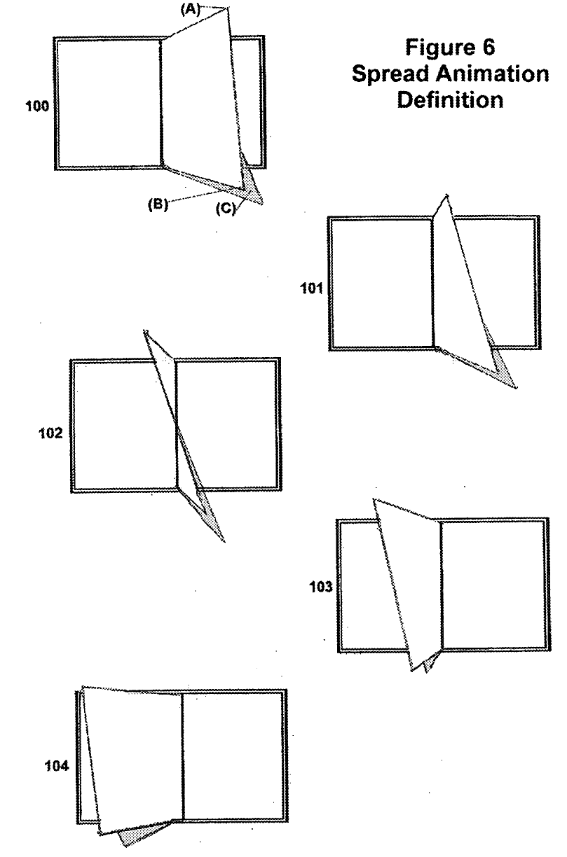

Depending on where the user clicks in the Presentation Player module, one of two things will happen. If the user clicks on an asset within the presentation that has link instruction attached to it, then the Presentation Player will follow those link instructions. For example, it may open a web browser, may take user to another spread, or even start some other multimedia process or program. However, if the received click is not on an asset with link instructions, the Presentation Player will then determine which side of the spread was clicked on—either the right side style graphic or the left side style graphic. Depending on this information, the Presentation Player will advance to the “next” spread or back up to the “previous” spread. Either of these conditions depends on whether there is a “next” spread and/or a “previous” spread available. For example, at the beginning of the Presentation Player module, the user cannot go to the “previous” spread (one does not exist); likewise, on the last spread, the user is unable to advance to the “next” spread (one does not exist). The act of navigating from one spread to another in the Presentation Player module is done through an animated process involving a series of frames of animations that generate a realistic book (see FIG. 6). At the end of the transition process, the Presentation Player updates its current spread index, “previous”, “next”, and “current” spread list and loads either the “next” spread of data or the “previous” spread of data. For example, if the current spread index is five (5) (“current”) and the user transitions to spread six (6) (“next”), the spread list is updated as follows:

“Previous” spread=“Current” spread

“Current” spread =“Next” spread

“Next” spread =load spread (current spread index+1)

This sequence is reversed when the “previous” spread needs to be loaded after navigating back wards.

FIG. 6 is the Spread Animation Definition shown in detail. Converting the spread layout into a set of polygons performs the animation from one spread to another spread. The right hand side of spread 100 is converted to a four-point polygon where two of the endpoints are fixed along the book axis; and the other two points are used to show the lifting of the page. The two points (A, B) traverse across the spread at different speeds exposing the “next” spread underneath them. In addition, part of the page turning motion generates a translucent shadow developed by a three-sided polygon cast from a simulated light source in the upper left hand corner of the spread. The cast shadow is emanating from the illusion of the page being lifted. During the frames of animation 101 A, B proceed toward the center of the spread where point A moves in both the horizontal and vertical direction and point B does the same at a different rate. This accomplishes the illusion of twisting the page 101. At a certain point, A has crossed the vertical axis and the four-sided polygon is now two unique triangles. The two triangles have textured map data in them where the upper triangle represents the left hand side of the “next” spread and the lower triangle represent the right hand side of the “current” spread 102. The transition of the size and shape and placement of the two triangles serve to perform the illusion of seeing both sides of the two spreads (“current”, “next”) at the same time. Once point B has crossed the vertical axis, a four-point polygon is now shown with data from the “next” spread only 103. Both A and B complete the animation 104 by both points coming to rest while traveling at different speeds to a point where the “next” spread is shown and there is no animated polygon on screen.

This entire process is reversed to show a “previous” spread. The different motion speeds of A and B can also be reversed as if to indicate to the user that the page is turning from the bottom as opposed to the page being turned from the top. This is reversible to show the “previous” spread as well.

What is claimed as new and is desired to be secured by Letter Pat. of the United States is:

1. Method of an online multimedia system for the building and playing of online presentations that have capabilities enabling an internet user to create, view and easily distribute presentations in a web browser, comprising of the following steps:
a) Registration of a user account enabling the user to login and logout at different times and places giving them access to create and update their presentations for a person using a personal computer;
b) Ability to name, describe, update and create presentations for a person using a personal computer;
c) Selection from a number of presentation styles where each style can control particular elements of how the presentation manifests itself in size, colors, sizing aspects and playback animations for a person using a personal computer;
d) Uploading digital assets online over the internet for a person using a personal computer;
e) Editing and orientation of digital assets online over the internet for a person using a personal computer;
f) Creation and selection of digital assets from the server in the form of thumb nailed tiny images representing the larger image to be selected;
g) Creation of thumbnail images to be placed on a single image for internet transmission and then for client side selection via a control file mechanism;
h) Creating a visual layout of digital assets, custom fonts, clipart and hyperlinks online over the internet supporting drag and drop operations for a person using a personal computer;
i) Global options such as compression type, aliasing, rendering formats can be chosen by the user when building their presentation;
j) The loading of a presentation script initialized at creation time is loaded at the beginning of the editing process and then upon exit of the editing process contains all the updated edits, placement, sizes, descriptions, colors, fonts and raster data that gets transferred back to the server;
k) The addition, uploading or linking to streaming music tracks, sounds and voice over narration for a person using a personal computer;
l) Ability to select particular tracks of streaming audio and particular points in the presentation for a person using a personal computer;
m) With or without a registered account the ability to view the presentation online in a playback environment with animation and streaming audio for a person using a personal computer;
n) Ability to send the user a simple link via email to view their presentation and share it with other users.

2. The method of claim 1 wherein said online multimedia system allows the user to view a realistic method of viewing pages in a familiar environment, similar to the conventional printed version of pages turning in a printed book while online.

3. The method of claim 1 wherein said online multimedia system allows for the decompression and accurate recreation of custom font and image raster data with or without saturation colorizing from within the playback environment.

4. The method of claim 1 wherein said online multimedia system allows for the dynamic real time creation of custom font and image raster data with or without saturation colorizing, anti aliasing and shadowing from within the playback environment.

5. The method of claim 1 wherein said online multimedia system, automatically enhances user's assets, clipart, text with real time anti aliasing, shadowing and translucent effects.

6. The method of claim 1 wherein said online multimedia system, packages all the assets and necessary pieces of a particular presentation together in a single entity allowing the presentation to be moved to different computer systems or networks for dispatching, downloading or playback.

7. The method of claim 1 wherein said online multimedia system, where the playback system can redirect audio streams or mix multiple streams based on the presentation's creator's sound preference and layout.

8. The method of claim 1 wherein said online multimedia system, where input text is drawn in a series of row widths, fonts, colors, types and styles based on the user's selection.

9. The method of claim 1 wherein said online multimedia system, where the playback system manifests itself in a plug in architecture or as a standalone program.

10. The method of claim 1 wherein said online multimedia system, where the playback system can read presentations from the local computer or from an internet server.

11. The method of claim 1 wherein said online multimedia system, where the playback system reads a presentation script and recreates the layout and imaging effects recreating the visual layout of the presentation in a animated and audio streaming environment.

12. The method of claim 1 wherein said online multimedia system, where the playback system renders the presentation in an animated book sequence that appears to lift off the users screen, extend beyond it's rectangular window or region and cast a shadow on the out lying portions of the display area.

13. The method of claim 1 wherein said online multimedia system, where the playback system renders the previous, current and next presentation set of slides allowing a faster transition and buffering of data whether the user advances or retreats the direction of the presentation.
